(19) United States
(12) Patent Application Publication
(10) Pub. No.: US 2014/0236695 A1
(43) Pub. Date: Aug. 21, 2014

(54) TRANSACTION LOG FOR LOYALTY BASED OFFERS AND AWARDS

(71) Applicant: RAWLLIN INTERNATIONAL INC., Tortola (VG)

(72) Inventors: Simon Shvarts, San Jose, CA (US); Ilya Oskolkov, Moscow (RU); Dmitry Bocharov, St. Petersburg (RU)

(73) Assignee: Rawllin International Inc., Tortola (VG)

(21) Appl. No.: 13/772,184

(22) Filed: Feb. 20, 2013

(51) Int. Cl. G06Q 30/02

(52) U.S. Cl. CPC G06Q 30/0224
USPC 705/14.25

(57) ABSTRACT

Financial transactions are tracked and a communication thread related to a financial transaction is generated. A reward stimulus is offered as part of and related to the communication thread. A third party vendor or a bank server can identify the communication thread and initiate a communication with the reward stimulus. A behavior profile can be generated based on the financial transaction and personal data including purchases tracked and spending habits. A communication exchange can be initiated on a mobile device as part of the communication thread based on predetermined options such as important dates, a geophysical location, social networking activity, a reminder, the behavioral profile, an inquiry and/or feedback received or published.

### CROSS-REFERENCE TO RELATED APPLICATIONS

The subject patent application is related to co-pending U.S. patent application Ser. No. 13/615,053, filed on Sep. 13, 2012, entitled “Behavioral Based Score,” which is hereby incorporated by reference in its entirety.

### TECHNICAL FIELD

The subject application relates to a transaction log and generating a one or more loyalty based offers and/or awards related to the transaction log.

### BACKGROUND

Loyalty programs or award based programs encourage consumer behavior toward making purchases and further patronizing particular businesses. For example, a card that is similar to a plastic credit card typically has a barcode or magnetic stripe that is scanned to identify the cardholder as a member of a loyalty program. Other identifying information may also be used for identification, such as the cardholder's phone number. By presenting the card or other identifying information, a purchaser is entitled to a discount on a current purchase in the store. Oftentimes, the loyalty programs require an application form that entails agreements by a retail store concerning privacy of data about the consumer. The store can use the data internally as part of marketing research. In some cases, the consumer can use the card to expedite verification during receipt of cheques or dispensing medical prescription preparations, as well as for other membership privileges.

The above-described deficiencies of today's loyalty based programs and promotional tools lend for the need to better serve potential clients. The above deficiencies are merely intended to provide an overview of some of the problems of conventional systems, and are not intended to be exhaustive. Other problems with conventional systems and corresponding benefits of the various non-limiting embodiments described herein may become further apparent upon review of the following description.

### SUMMARY

The following presents a simplified summary in order to provide a basic understanding of some aspects disclosed herein. This summary is not an extensive overview. It is intended to neither identify key or critical elements nor delineate the scope of the aspects disclosed. Its sole purpose is to present some concepts in a simplified form as a prelude to the more detailed description that is presented later.

Various embodiments are disclosed that employ one or more financial transactions recorded on a client device to provide a reward to a client as part of a conversational thread related to the one or more financial transactions. The reward can include, for example, a discount, a credit, a recommendation, a loyalty based point, a referral, a promotion, a product, a service and/or other reward stimulus as part of and continuing the conversational thread related to a previous transaction. In one embodiment, an apparatus (e.g., a mobile device, personal digital assistant, etc.) includes a memory to store computer-executable instructions, and a processor, which is communicatively coupled to the memory. The processor and memory facilitates execution of the computer-executable instructions to at least identify a conversational thread related to a financial transaction stored in the memory. A conversational thread can include a set of communications that are related to one another in subject and/or as part of a series of responses to a communication message, for example. A communication message is generated that is related to the financial transaction as part of the conversational thread. A reward (e.g., a promotion, a discount, a credit, a recommendation, a referral, a loyalty based point, an award, etc.) is offered as part of and related to the conversational thread.

In another embodiment, a system comprises a memory that stores computer-executable components and a processor, communicatively coupled to the memory, which facilitates execution of the computer-executable component. The computer-executable components comprise a profile component configured to generate a behavioral profile based on a set of financial transactions recorded on a mobile device. An interaction component is configured to facilitate a communication thread with a communication based on the behavioral profile. A reward component is configured to generate an offer with a reward stimulus as a part of and related to the communication thread.

In another embodiment, a method comprises tracking, by a system comprising at least one processor, a set of financial transactions. A conversational thread is identified that corresponds to the set of financial transactions. A reward stimulus is communicated via a mobile device as a part of and relating to the conversational thread.

In another embodiment, a tangible computer readable storage medium comprising computer executable instructions that, in response to execution, cause a computing system to perform operations. The operations include tracking a set of financial transactions. A message is communicated as part of a conversational thread that is related to the set of financial transactions. A reward stimulus is communicated in the message that is related to the set of financial transactions and based on a set of predetermined options.

The following description and the annexed drawings set forth in detail certain illustrative aspects of the disclosed subject matter. These aspects are indicative, however, of but a few of the various ways in which the principles of the various embodiments may be employed. The disclosed subject matter is intended to include all such aspects and their equivalents. Other advantages and distinctive features of the disclosed subject matter will become apparent from the following detailed description of the various embodiments when considered in conjunction with the drawings.

### BRIEF DESCRIPTION OF DRAWINGS

Non-limiting and non-exhaustive embodiments of the subject disclosure are described with reference to the following figures, wherein like reference numerals refer to like parts throughout the various views unless otherwise specified.

FIG. 1 illustrates an example system for providing rewards in accordance with various aspects described herein;

FIG. 2 illustrates another example system in accordance with various aspects described herein;

FIG. 3 illustrates another example system in accordance with various aspects described herein;

FIG. 4 illustrates an example index component in accordance with various aspects described herein;

FIG. 5 illustrates an example view pane in accordance with various aspects described herein;

FIG. 6 illustrates an example view pane in accordance with various aspects described herein;

FIG. 7 illustrates a flow diagram showing an exemplary non-limiting implementation for a system in accordance with various aspects described herein;

FIG. 8 illustrates a flow diagram showing an exemplary non-limiting implementation for a system in accordance with various aspects described herein;

FIG. 9 is a block diagram representing exemplary non-limiting networked environments in which various non-limiting embodiments described herein can be implemented; and

FIG. 10 is a block diagram representing an exemplary non-limiting computing system or operating environment in which one or more aspects of various non-limiting embodiments described herein can be implemented.

### DETAILED DESCRIPTION

### Overview

Embodiments and examples are described below with reference to the drawings, wherein like reference numerals are used to refer to like elements throughout. In the following description, for purposes of explanation, numerous specific details in the form of examples are set forth in order to provide a thorough understanding of the various embodiments. It will be evident, however, that these specific details are not necessary to the practice of such embodiments. In other instances, well-known structures and devices are shown in block diagram form in order to facilitate description of the various embodiments.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon such as with a module, for example. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements. In addition, the term “set” refers to “one or more.”

In consideration of the above-described deficiencies among other things, various embodiments are provided for a mobile transaction log (recorded financial transactions and any corresponding communication exchanges as a communication/conversational thread) to generate loyalty based offers and awards as a reward stimulus. For example, a transaction can be identified as a communication exchange of a communication thread (e.g., a text message based exchange, electronic mail, and/or the like), which can be used to provide dynamic opportunities with reward stimulus for a user. A reward stimulus, for example, can be a part of, a continuation to and/or related to the communication thread, and can also include one or more reward options that are related to a third party vendor, and/or a banking server. The reward stimulus can comprise one or more promotions, discounts, credits, recommendations, referrals, loyalty points, etc. for a banking entity and/or a third party vendor, and can be related to the communication thread or the subject matter (e.g., product/service of the transaction) of the communication thread. The third party vendor, for example, can have access to and further add to the communication thread via a mobile device of the user, in order to facilitate greater customer relationships and business. In addition or alternatively, a banking server can provide the reward options as relating to the third party vendor as a separate entity, and/or for promotions with the banking server itself. The reward options can be further based on a set of predetermined options such as, for example, an important date tracked, a geophysical location, a time of day, social networking activities, reminders, a behavioral profile, an inquiry detected or feedback received about the financial transaction.

A conversation or communication thread as used herein can include a conversation exchange involving a transaction from the same vendor and user, such as from a vendor server and via a client device. For example, a conversation exchange could originate from a user submitting a purchase as a ticketed item for checkout, and an additional message could be generated following up with a receipt and/or shipment notice, which could be from the vendor of the item. Any number of conversational exchanges could then follow between a customer and/or vendor as part of the same conversation or communication thread.

In one example, a profile component is configured to generate a behavioral profile based on financial transactions recorded on a mobile device. An interaction component is configured to facilitate a communication thread with a communication based on the behavioral profile. A reward component is configured to offer a reward stimulus as a part of and related to the communication thread. Additionally, a feedback component is configured to enable a feedback measure that is related to the communication thread. The feedback measure can be included within the communication thread having the reward stimulus as further information provided to the user. The feedback measure can also be generated via an interface control that enables feedback (e.g., a like rating, a comment attachment, etc.) to rate the financial transaction that the communication thread is associated with. The feedback can be further published to one or more networks, such as part of an overall user rating related to an entity involved in a transaction associated with the communication thread and/or as a separate individual rating or a private rating that is not published. Further examples, details, and embodiments are explained in additional details below.

### Non-Limiting Examples of Transaction Log for Loyalty Based Offers and Awards

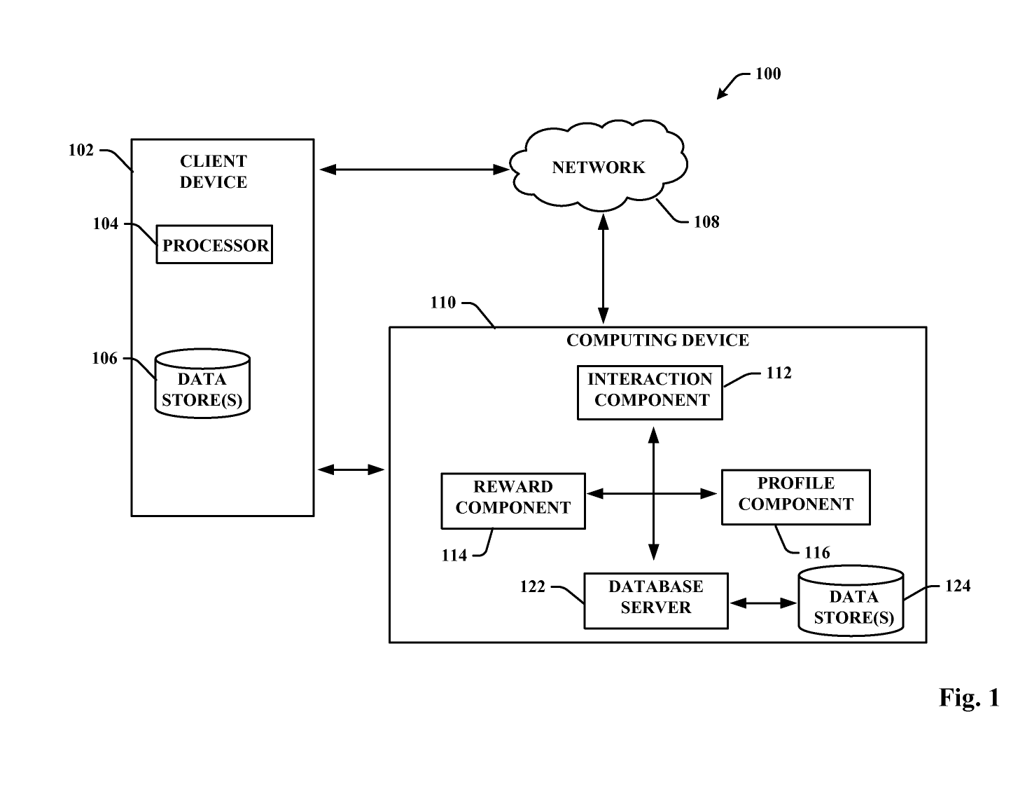

Referring initially to FIG. 1, illustrated is an example system 100 to provide rewards to clients in accordance with various aspects described herein. The system 100 is operable as a system to converse with a client, such as via a communication thread comprising text messaging, electronic mail, iMessage, chat communication and/or the like that includes a set of communications related to a common subject (e.g., a financial transaction comprising a transactional log, transactional record and the like), and/or as part of a set of responses or exchanges to one of the communications. The system 100 operates to generate reward stimulus (e.g., promotional offers, credits, discounts, recommendations, referrals, reviews, assistances, products, services and/or the like) as relating to and as a part of one or more past financial transactions. The conversational thread, for example, can be identified, generated by a compilation, and/or further continued dynamically as part of the conversational thread based on the financial transaction recorded/logged and/or as part of a client/behavioral profile. A profile or behavioral profile of a client, for example, can be generated from continuously learning the client, behaviors of the client and/or dialoguing with the client based on the knowledge learned on a periodic basis and in relation to the financial transactions logged on a client device, at a banking server, and/or other third party entity. The system 100 can further operate, for example, to provide opportunities for education on available offers, a product, a service, a reward offer, a credit recommendation, a discount, a loyalty based program, feedback, and provide recommendations to third parties for marketing strategies, which is based on the financial transactions and related communications identified from a transactional log. An additional reward stimulus can be part of and corresponding to the transactional log also.

The system 100 includes, for example, a client device 102 that can comprise a computing device, a mobile device and/or a mobile phone that is operable to communicate one or more messages via an electronic digital message (e.g., a text message, a multimedia text message, and the like) and/or a voice message with an audio output/input (e.g., speaker, microphone, etc.) as part of a set of communications. The client device 102 includes a processor 104 and at least one data store 106 that processes and stores exchanges of a financial transaction having an interaction (e.g., a set of conversations, exchanges, and/or communication threads) as well as stores a behavior profile, which can be generated from personal data analytics related to the client and/or the financial transaction. A conversational thread, for example, can be generated, identified, and/or continued from the financial transaction and exchanges observed, which can include a number of responses or behaviors of the client that can be generated and/or tracked from one or more devices. A reward stimulus that includes one or more reward options can then be generated as a part of the communication thread and as a continuation of the transactional exchanges.

The client device 102 is operable to communicate content via the network 108, which can include a cellular network, a wide area network, local area network, and/or other type network. The client device 102 is further operable to communicate to other devices or systems, such as to a computing device 110. The network 108 can also include a cloud network that enables the delivery of computing and/or storage capacity as a service to a community of end-recipients that entrusts services with a user's data, software and computation over a network. Additionally, the client device 102 can include multiple client devices, in which end users access cloud-based applications through a web browser, a desktop and/or mobile app, and to resources of the networked system 110.

The system 100 includes the computing device 110 that is communicatively connected to one or more servers and/or client devices via the network 108 for receiving user input, gathering personal data in a user profile, identifying financial transactions by the user, and communicating with the client through a financial conversation or financial dialogue exchange. The computing device 110 can be housed by the client device 102 and/or operate separately in communication with the client device 102. The network 108 is communicatively connected to the computing device 110, which is operable as a networked host to provide, generate and/or enable message generation on the network 108 and/or with the client device 102 either directly or via the network 108. The computing device 110 can include a database server 122 that is communicatively coupled to one or more data stores 124, such as public and/or private networked data stores, which include telephone data stores, banking data stores, social networks, and the like. The database server 122 can collect data related to the client for a user behavioral profile to be generated from data gathered from the one or more data stores 124 and from observational data identified from conversations and/or transactional logs with the client device 102, with the computing device 110, and/or from data related to various described components and systems described herein. For example, the computing device 110 can include an interaction component 112, a reward component 114, and a profile component 116, as well as with other various components, in which each can include hardware and/or software.

The interaction component 112 operates to interact with the user of the client device 102 and generate/identify a conversational thread related to a financial transaction. The financial transaction can be a purchase, an exchange, a bargain for services/products, etc. with the computing device 110, a third party vendor and/or separate a banking server. The transaction can be recorded on the data store 124 and/or 106 of the client device 102 and presented to a user, via the interaction component 112, as a text based message, such as a text messaging service, an electronic mail, digital message or the like. The interaction component 112 can operate to further facilitate the communication thread by communicating a message or response as part of the communication thread, such as by presenting the financial transaction in the communication thread with a follow up message having a reward stimulus and/or feedback that is related to the transaction.

The reward component 114 is configured to generate an offer that comprises a reward stimulus for the communication thread. The reward stimulus can be a promotion, a discount, a credit, a recommendation, a referral, a loyalty based program, awards, an inquiry to the user, and/or additional information related to the financial transaction, the vendor, and/or a banking server. The reward stimulus can include reward options that a user can select via the client device 102 for further inquiry, review, purchase, and/or redemption. The reward options can include one or more vendor related products/services that could be similar to the products and/or services of the financial transaction. Alternatively or additionally, the reward options can be communicated from other vendors that the system 100 determines that the user could like based on the communication thread related to the financial transaction.

In one example, a financial transaction can involve a product from a vendor, in which the interactions or exchanges are stored in the data store 106 of the client device 102 and/or the data store 124. The computing device 110 and/or a third party vendor can communicate with the client device 102 a reward stimulus (e.g., loyalty based offers, awards and the like) as part of the same conversational thread from a past or logged transaction, and/or as part of a compiled thread from different communications of the past or logged transaction. The client device 102 can receive a message via the interaction component 116 that presents the transaction as continuous with the conversational thread. The reward stimulus can be generated, via the reward component 114, from the content or subject matter of the conversational thread such as a discount on a similar product, which could also be an offer from the same vendor or a different vendor, and/or via a banking server.

The interaction component 112 can generate a set of dialogues, recommendations and/or suggestions that facilitate a conversation as part of a communication thread, which is related to a behavioral profile and/or financial behaviors of a user stored on the client device 102 as part of a behavioral profile or separate. For example, the interaction component 116 can facilitate dialogue in the communication thread based on a set (one or more) of predetermined options, which can include an important date tracked, a geophysical location, a time of day, social networking activities, reminders, a behavioral profile, an inquiry detected or feedback received about a financial transaction.

For example, a transaction stored on the client device can be stored and tracked as part of a user's spending habits. As a birthday reminder approaches, for example, the computing device 110 could interact with the client device 102 via the interaction component 112 and generate a reminder and a suggestion for a product or service similar to the transaction and/or a service/product from the same vendor. The interaction component 112 can thus dynamically interact with the user via the client device 102 to understand likes and dis-likes, various personality characteristics and/or other potential interest items from a behavioral profile that is dynamically and iteratively generated, in which can further include client feedback and feedback options as further discussed below. The system 100 can generate and/or identified communications from past financial transactions and facilitate communication related to one or more of the financial transactions and/or as part of a conversational thread from the one or more financial transactions to promote a reward stimulus for an important data, an interest of the user, geophysical location, etc.

The computing device 110 can facilitate the conversational thread via the interaction component 112 from various means or multiple channels, such as a voice generated interaction, key pad interaction, chat interaction, iMessage, video (e.g., for sign language communication and the like) and/or interactions, in which advice, suggestions, financial interactions, conversations and/or the like can be tracked via the client device 102, such as via a digital wallet, bank account aggregators, and other such information sources of financial data related to the client's behavior.

In one example, a user interacts with the computing device 110 via the client device 102 through one or more channels for a conversation or voice exchange such as iMessage, voice exchange as operated by the interaction component 112. The interaction component 112 can dynamically respond to various responses, answers, statements, actual financial behavior, such as recent transactions, savings, debits and credits, rent payments and any other such financial related behavior (transaction) associated with the client via the client device 102. In one embodiment, the interaction component 112 can operate to converse, exchange and/or initiate dialogue with a client based on one or more user preferences, such as a tone (e.g., a voice tone, text language tone), a language, a gender, a voice (e.g., celebrity voice or other voice), a dialect and/or a grammar construction. A user can set the user preferences and the user preferences can be changed dynamically by the system 100 based on circumstances and data gathered from personal data analytics and personal behaviors identified. For example, where the user opens up an investment account, the interaction component 112 can operate to provide investment advice, knowledge about investment decisions, and/or other financial data based on the users income, interest, savings, and the like data about a financial condition of the user, and/or from any other transactions (e.g., a purchase at a gift store).

The profile component 116 is configured to analyze the data obtained from the client device 102, a data store (e.g., data store 124) and/or some other device, component, network 108 or system (e.g., a digital wallet, bank account aggregators, and the like). The profile component 118 is configured to identify and/or determine financial behavior data from various data stores, conversational exchanges, and/or transaction data from financial transactions in order to determine various data indications of the client's behaviors and/or likes, dislikes, and/or general profile such as marital status, children, age, interests, location, important dates, etc. by which a behavioral profile can be created to predict how and in what manner the user could behave according to future and past financial transactions, for example.

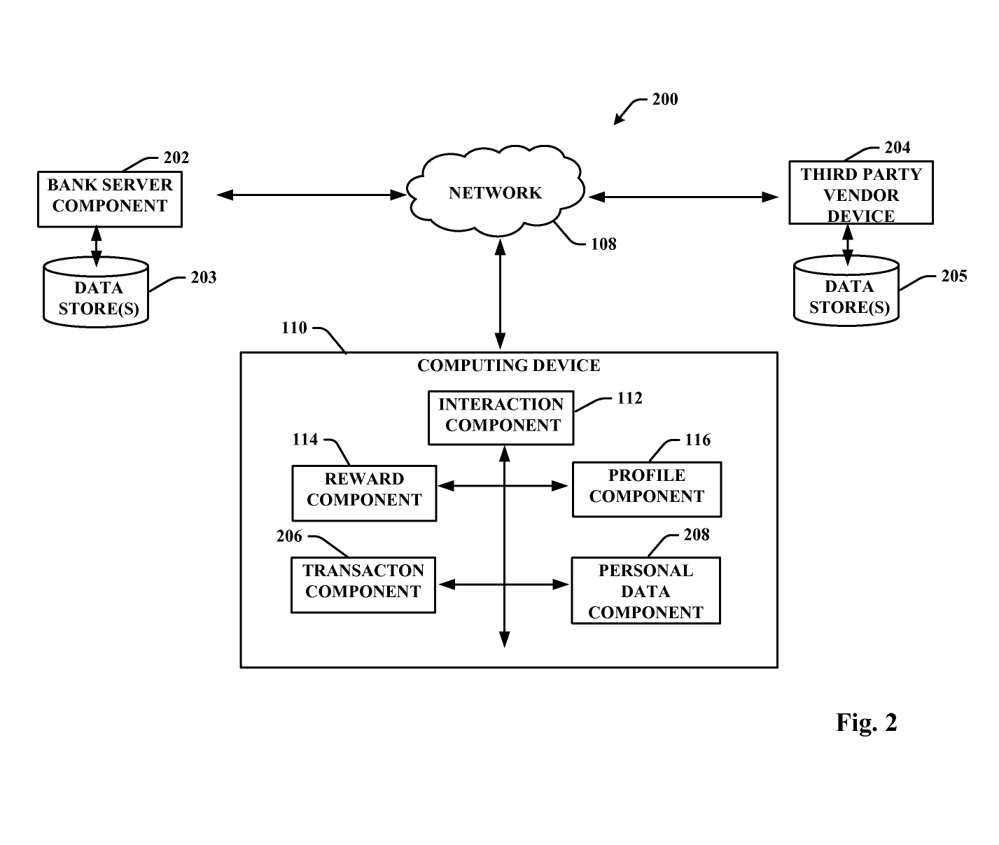

Referring now to FIG. 2, illustrated is another example system 200 that includes the computing device 110 in accordance with various embodiments disclosed herein. The system 200 operates to interact with a client via the computing device, which can include a client device, personal digital assistant, personal computer, mobile device such as a mobile phone, laptop, notebook and the like. The system 200 comprises a banking server component 202, a third party vendor device 204, the network 108 and also the computing device 110. The computing device 110 comprises similar components as discussed above and further includes a transaction component 206 and a personal data component 208.

The transaction component 206 is configured to generate a transaction log or record that can be used to continue a communication as part of a conversational thread or a series of communications related to a financial transaction. A client, for example, can conduct business or an exchange for a product or service with the computing device 110, in which one or more communications can occur during the process via chat, electronic mail, text messages, and/or the like. The communications can be continued as part of a single communication thread, and/or compiled into one thread in order to respond within a thread to the user with a message having a reward or reward stimulus that is associated with the thread.

For example, the client could purchase a book from a book store, either online over the network 108 or in person, in which communications are generated. The communications can include a request to purchase or a purchase order, a receipt, and/or one or more additional communications. The communications can be digitally generated and stored on the user's device (e.g., mobile phone, etc.) and stored in the transaction component 206 in order to keep track of each of the set of communication exchanges. The communication exchanges (e.g., the order, the receipt, shipping confirmation, etc.) can be integrated as one thread. At a later time, the vendor, such as the third party vendor device 204 can access the transactional thread from the user's device 110 and/or communicate a reward stimulus to the device 110 with a message that continues from the thread and is a part of the thread with additional communications having rewards such as a promotion, discount, loyalty based points, awarded credit, recommendations, referrals to additional products or services, etc. The reward stimulus could be associated with incentives for purchasing additional books at the vendor device 204 (e.g., a network portal, a website, the vendor retail systems, etc.), be related to books related to the book purchased by subject matter, age range, genre, etc., and/or be related to the same vendor but other products or services (e.g., magazines, backpacks, coffee, music, etc.).

The personal data component 208 is configured to determine a set of personal data analytics based on a set of inputs that relate to financial data identified from the transaction record. From the user/behavioral profile generated via the profile component 116, the personal data component 120 can determine personal data analytics that indicate information about a user's interest, preferences, financial conditions, personal settings, dates (e.g., anniversaries, birthdays, calendar events, etc.), spending and/or investment habits, location (e.g., global positioning), language, holidays, schedule, transactional histories and/or other facts pertaining to the user's personal context or present surroundings, in which the user finds himself or herself.

The personal data component 208 can operates to enable the interaction component 112 to dynamically dialogue and provide financial feedback, knowledge and assistance to a consumer with communications that are a part of past financial transactions based on the personal data of the user. The personal data component 208, for example, is configured to determine personal data analytics or personal analytic data based on inputs related to financial data identified through conversation via the user device with the client, through user profiles in data stores and/or from data collected about the user's behaviors and/or interactions with other parties via the network 108.

Personal data analytics can include indications, probabilities, and/or classifications that are negative, positive, or neutral, and can be used to provide a financial score or to measure how a user will respond and what information could be pertinent to the user's financial condition for interactive dialoguing and presenting a reward stimulus for the user from a third party vendor device 204, a banking server 202, and/or the computing device 110.

The banking server component is configured to communicate at least one transaction to the profile component and prompt the interaction component 112 to initiate the communication thread such as by generating the communication thread from previous communications or by further initiating a communication as a part of the thread. The banking server component 202 can include a banking institution having a data store 203 that a user can opt to participate in a rewards program or a similar loyalty based plan. The banking server component 202 can manage and/or operate the computing device 110 and corresponding components therein. For example, as transactions are logged and a user develops spending habits, the banking server 202 could further tracks rewards programs that are either affiliated with the particular banking server 202 and/or with one or more third party vendor devices 204 with one or more data stores 205. The rewards communicated to the client can thus be part of previously recorded transactions in order to efficiently provide to the user items or services that would potentially be more interesting than just anything and/or anyone offering a discount. In particular, the timing and relevance of the communication can be related to important dates, social activities, holidays, and the like for making the reward stimulus (promotion, discount on a product or service, credit, loyalty points to a particular vendor such as the vendor device 204, and other awards) more pertinent to the user and have some context related to the user's daily context.

The profile component 116, for example, can be further configured to generate the behavioral profile based on the set of personal data analytics ascertained by the personal data component 208 and also to determine items of potential interest from the set of personal data analytics. The interaction component 112 can thus also be further configured to facilitate the communication thread based on the set of personal data analytics or the items of potential interest therefrom.

For example, a user or client that has purchased a book could receive a communication that provides for an additional book with a related subject matter in response to a spouses birthday approaching. In addition, one or more reward options could be presented based on a number of circumstances surrounding a financial transaction that is recorded. Because the system 200, can track transactions and the client's personal circumstances, various rewards could be communication as part of past transactions. For example, a book related to a daughter's college could be suggested from the same vendor based on the fact that the daughter goes to a certain university. For example, the system 200 could communicate a reward option as comprising a book about the history of the University of Ohio. The communication could be timed to be a few months before a daughter's graduation from the University of Ohio and suggest in a communication from a transaction related to the same subject matter and/or the same vendor. The communication could be from the client device based on feedback related to the book and the transaction logged, from the vendor device and/or from the banking server component, for example.

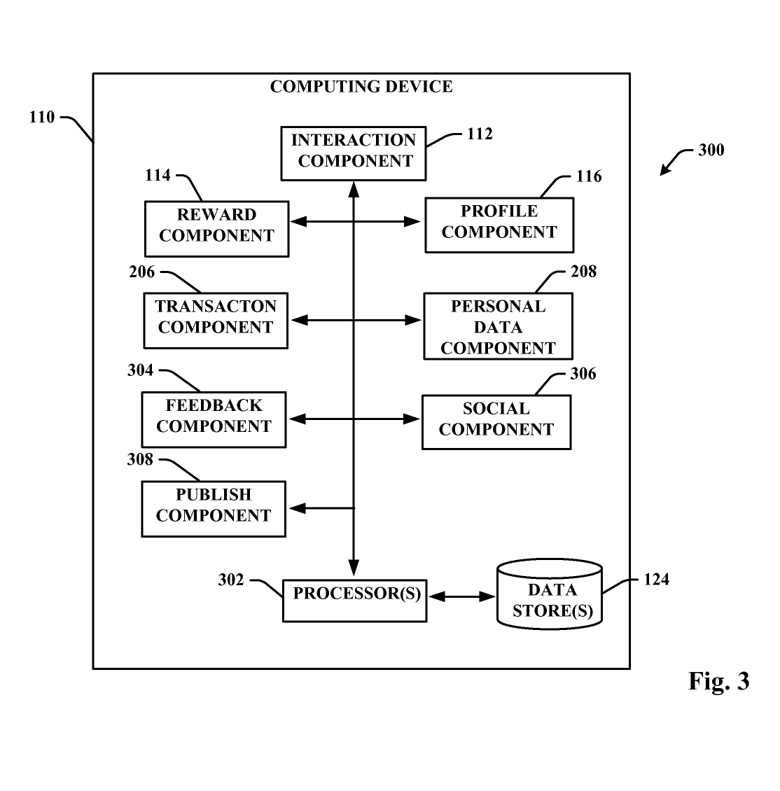

Referring now to FIG. 3, illustrated is a system 300 for generating rewards based on a conversational thread related to a financial transaction. The system 300 includes the components discussed above, and one or more processors 302 that can function respectively for and/or as the components discussed. The system 300 further comprises a feedback component 304, a social component 306, and a publish component 308.

The feedback component 304 is configured to enable a feedback measure that is related to a communication thread that has been assimilated and/or stored at the data store 124, for example, other data store, on a third party vendor device and/or a banking server component (e.g., a banking institution server and the like). The feedback component 304 can operate to generate a feedback measure to rate a financial transaction that the communication thread is associated with and/or provide a rating associated with a third party vendor or other entity associated with the financial transaction.

In one example, the reward component 114 can operate to generate reward options based on feedback provided from one or more users. For example, a client could have shopped at a sporting goods store and purchased deer bait. As a hunting season approaches for deer, the same vendor and/or other vendors could access the computing device according to permission or approval protocols and use the conversation thread or transactions generated into a thread for providing reward options for deer hunting equipment. The different stores and products could be associated with different ratings or user reviews with the different reward options. The feedback can be from reviews that the vendor supplies, and/or from specific groups, such as those involved in the same communications or rewards, local residents to the store near the client, and/or other defined groups according to the computing device 110. In this manner, a client can be presented rewards according to various context or circumstances surrounding the client, data about the client, and/or past transactions, which can provide a greater relevance for the client to be offered particular rewards.

In another example, a user's personal bank could operate via a banking server component to offer rewards from third party vendors that are based on feedback surrounding local vendors, products the user has been interested in previously, and/or circumstances or contextual facts surrounding the client. Rather, than having one or more sets of rewards, the rewards can operate dynamically based on a client's circumstances and also on rewards or promotional events at local stores depending upon the location of the client. For example, if a restaurant or other vendor that the client enjoys is offering discounts at a particular location, these rewards could be communicated to the client in the form of reward stimulus. Examples of grocery stores or music shops in the area could be provided to the client based on food or music that were respectively purchased and recorded with the client device or computing device 112, for example.

The social component 306 is configured to generate an interface control that can enable a single input to associate feedback to a feedback measure for a financial transaction that is stored in a transaction record or the behavioral profile. For example, one or more communication threads related to a subject matter such as a particular vendor, a product, service and/or other similar related subject matter can be presented to the user via the computing device 110. The user can then provide comments in a comment section, provide a rating based on stars or some other rating system, like, or dislike, according to a respective user interface control. In one example, the single interface control can be a like button, which can attach likes to the thread.

The computing device 110 can further include the publish component 308 configured to publish the feedback with one or more networks or network portals. This can enable a user to share the information publically and be used for other rating databases other than in the data store 124. Accordingly, the system 300 can provide ratings for general reviews of a general wife collection of review and/or ratings for local reviews based on a geographical location that the user has indicated as favorable or not for the profile from the profile component. The published feedback can be in the same form as discussed above and/or in other such forms of feedback (e.g., comments, reviews, a stared system, a color system, a numbering system from one to ten, etc.).

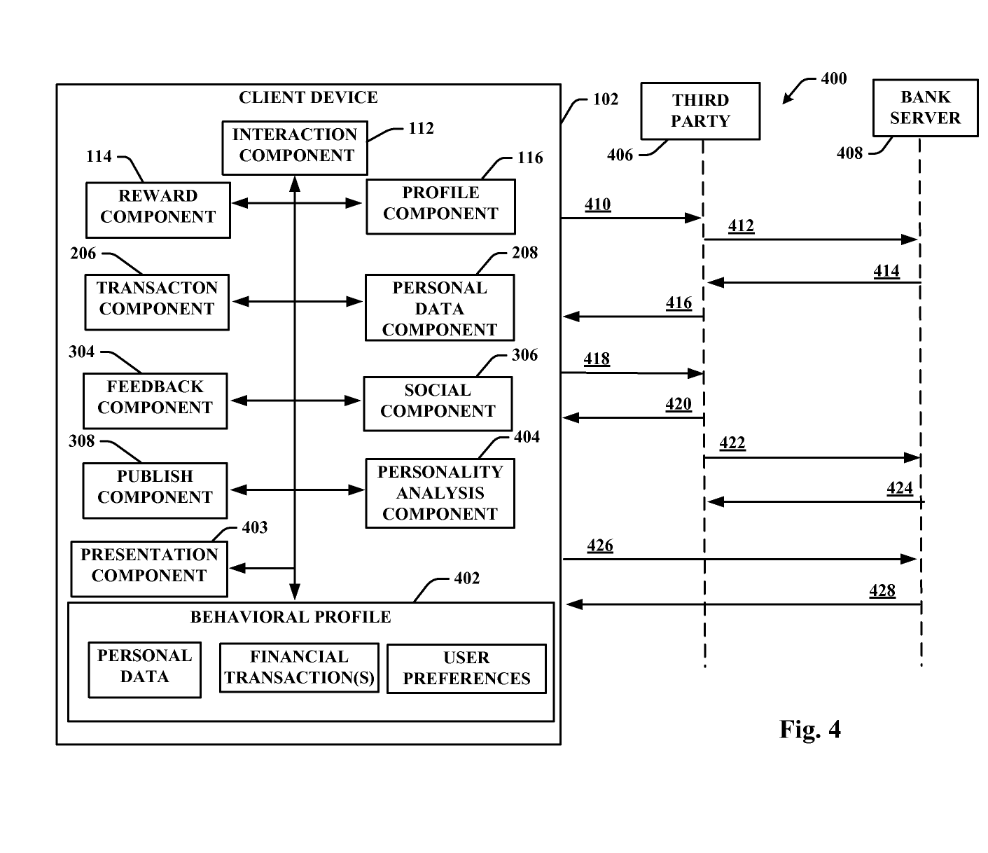

Referring now to FIG. 4, illustrated is a system 400 that includes one or more components as discussed herein in accordance with various embodiments. The system 400, for example, includes the client device 102 comprising components discussed above and further includes a presentation component 403 and a personality analysis component 404. The components discussed herein can be included in different architectures other than the examples provided for explanation, and thus, the embodiments described in this disclosure are not limiting or precluding to other systems or devices. For example, the presentation component 403 and the personality analysis component 404 can be comprised by the computing device 110 discussed above. Also, the components can be comprised as resources on a cloud network, such as the network 108 as a further example.

The client device 102 is operable to receive inputs during and from a conversation, exchange and/or, in other words, a financial interaction related to a set of financial transactions, which can be formed into a conversational thread and/or already part of a conversational/communication thread. The interaction or exchange, as discussed herein, can be a conversation that is carried out live via text, instant messaging, voice over telephone, and the like, in which the voice input from a client on a client device (e.g., mobile device, phone, computing device, etc.) is converted to words and/or phrases in text. Additionally or alternatively, the interaction between client device 102 and one or more vendors such as the third party 406 (a third party device) and/or a bank server 408 (banking server device), can be via a text exchange, instant messaging exchange, or any conversational dialogue that includes data being exchanged for a transaction, as a conversational thread, and/or as information gathering.

In one embodiment, the presentation component 403 can render the communications in a display (not shown) as a communication or conversational thread for a client to observe. The personality analysis component 404 is configured to determine a set of user preferences based on the behavioral profile, which can include potential interests and/or a client's present circumstances. In response, the interaction component 112 can operate to facilitate the communications based on the set of user preferences, which can include a tone, a gender, a dialect, a language, and/or a grammar construction, for example. The interaction component 112 is further configured to initiate the communication based on a set of predetermined options including based on at least one of a date tracked, a device geophysical location, a time of day, a social networking activity, a reminder, the behavioral profile, an inquiry detected or feedback received about the set of financial transactions.

The profile component 116 can be utilized to track purchases and analyze spending habits determined from the purchases to generate the behavioral profile 402. The behavioral profile 402 can include personal data, financial transaction data (e.g., transactional communications and content therein), and the user preferences discussed above.

For example, the behavioral analysis component 118 determines indicators, such as detected behaviors, words or phrases that indicate a behavior to a recommendation, an interaction or financial transaction and updated personal data retrieved about the client, such as social activities, geolocation (e.g., global positioning system location), events or important dates to the client (e.g., birthdays, holidays, anniversaries, products or services of potential interest) and the like spending patterns or behaviors. The client's spending habits, for example, can comprise at least one of payment patterns, debt accumulation data, expense data, income data, and/or interest rate data from the set of financial transactions, in which a bank server or banking entity and/or a third party vendor can access to provide reward stimulus with various financing opportunities (e.g., a six month same as cash plan on items for home improvement, and the like).

Various data sources, including the data store 124 and other internal and external data stores, can be employed for determining information about the user for a behavioral profile that predicts and/or learns user behaviors including likes, dislikes, personality information and data, etc. Information about the client can be searched with key search words (e.g., name, data of birth, email addresses, and the like) in one or more data stores. The data is collected and stored in a user profile 402. The profiles of the client can contain client characteristic data that includes information collected over the any number of data bases, which can be utilized by the interaction component in communication with the other components discussed to provide reward options to a user based on the user's circumstances or a relevant context as part of a communication thread related to a past financial transaction.

In one example, the client device 102 operates to collect and respond to information about a user via client devices, networks, data store(s), a bank aggregate data store, user profiles, communication with the user via the communication component 310, and/or financial transactions or other transactions. The client device 102 can determine contextual information to further aid in determining how to communicate with a user. For example, a geolocation information can be obtained (e.g., a Global Positioning System location, travel itinerary data, inputted data, and the like) in order to ascertain the location of the device 102 and/or the user that the device is in communication with for continuous dialoguing. Additionally, recent payment activity, electronic interactions with social media and/or electronic conversations (email, chat, etc.) can be analyzed and identified by the context component for communication to other components of the system. The interaction component 112 is further able to identify dialogue statements, questions, and/or communicate with a user based on his or her context or environment.

Characteristics or attributes are assimilated as metadata associated with the client profile in storage, for example, and can be from data sources that can include virtually any open source or publicly available sources of information, as well as private sources, including, but not limited to websites, search engine results, social networking websites, online resume databases, job boards, government records, online groups, payment processing services, online subscriptions, and so forth. In addition, the data sources can include private databases, such as credit reports, loan applications, and so forth.

The personality analysis component 506 is configured to determine user preferences dynamically by updating personal data analytics about the user. For example, as a user responds in a certain tone, the personality analysis component 506 can identify the user's vocal tone and response according to a different tone to the user than in a previous conversation with the same user. Other user preferences can also be modified, such as with a dialect or sentence phrases (e.g., slang, different levels of sophistication, etc.) as different moods, catch phrases, taste and/or habits (e.g., enjoys one thing over another) of the user are detected.

At a communication 410, for example, the client device 102 can communicate with a third party 406 for purchasing a product or service as a purchase order, which could initiate a conversational thread. The third party 406 could further process a communication 412 for a payment via a communication with the client's bank at a bank server 408 (e.g., a credit, debit card, check and/or other instrument). The bank server 408, in turn, returns payments with a communication 414. The third party 406 can further communications at 416 with a processed order, which can include a shipping date, a receipt, a confirmation of payment and processing, etc. The client device 102 could further respond at 418 with a communication, which can be at a later date/time, or as part of the same transaction. For example, the third party 406 could receive an update of the client's condition from the profile, either that feedback has been provided as related to the communications involving the transaction, as a pending social date, and/or any other circumstances that could provide opportunity to inform the third party to generate an offer 420 a reward stimulus (e.g., a promotional offer, discount, credit, etc.) to keep the customer happy and returning.

Alternatively or additionally, the client device 102 can be in a trusting relationship with the bank server 408 and be provided communications 426 as part of the previous communication thread (e.g., including one or more of communications 410, 412, 414, 416 and/or 418, etc.), which is similar to the communication 418 to inform of the status, circumstances, feedback, transactional data, and the like to afford the client device opportunity to receive reward stimulus (e.g., promotions, discounts, credits, and the like as discussed) with the bank server as part of financing and/or financially related instruments, and/or with the third party and/or with a related third party or product/service, for example. Alternatively, the communications 422 could originate from the third party 406 to the bank server 408 based on the communication 418 and the user defined preferences for information sharing. In response, the bank server 408 could promote financial rewards to incentivize the third party 406 and work together to generate a communication 420 and/or 428 for an offer on financing, products, services and the like to the client device 102 based on past transactions and the conversational threads generated therefrom or compiled thereafter by the client device 102.

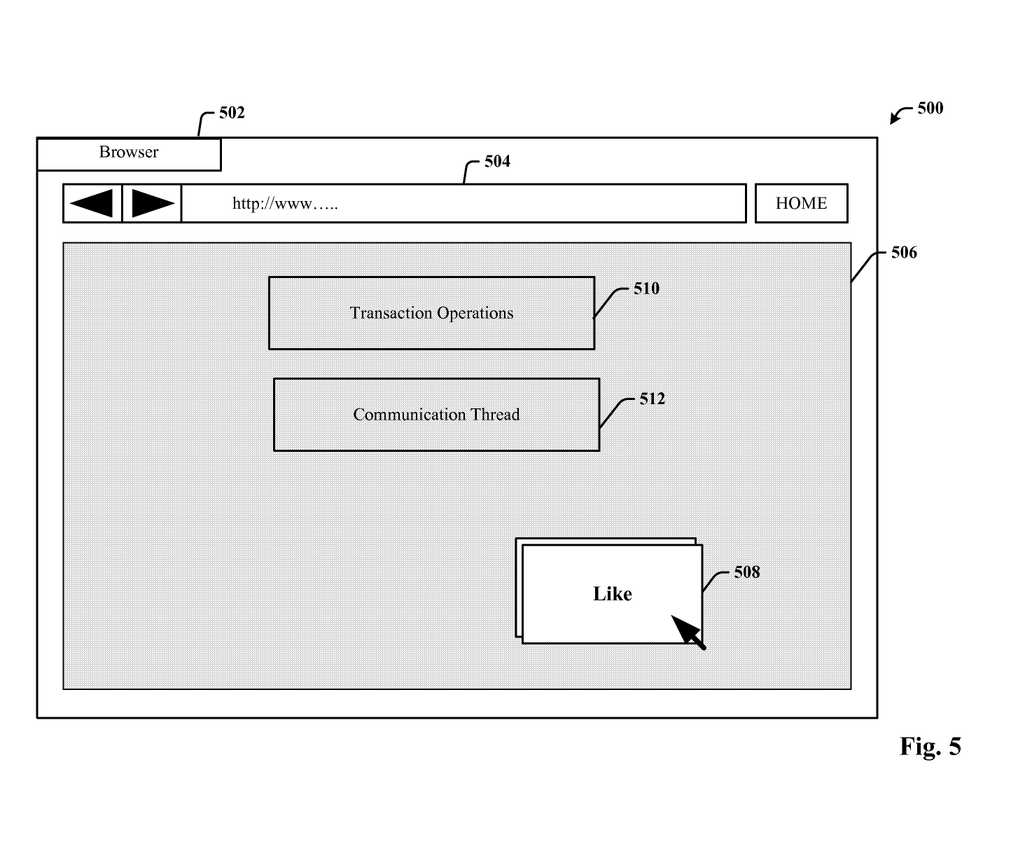

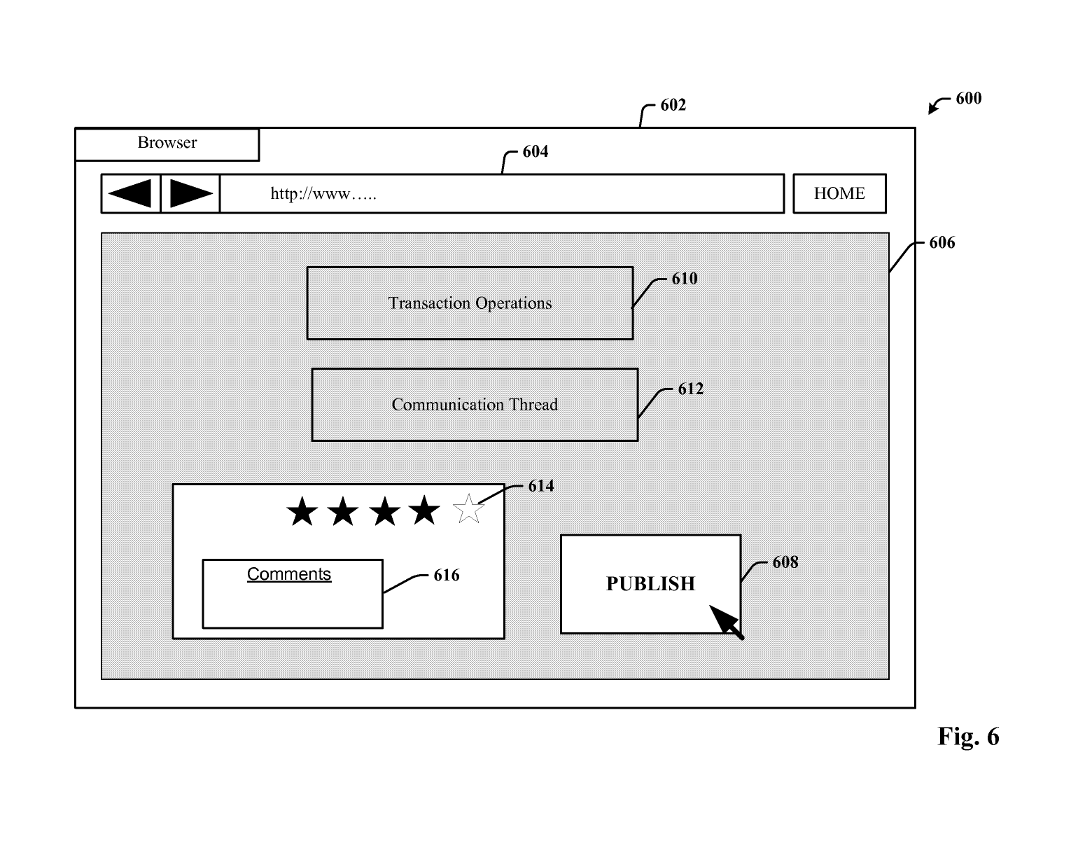

Referring now to FIG. 5, illustrated is an example feedback viewing pane 500 in accordance with various aspects described herein. As discussed previously, the feedback component 304 can provide a feedback measure (e.g., a number of likes) and/or whether a transaction 510 such as a product or service is liked by the client device. In addition, the feedback can be associated to the communication thread 512 to rate the communications or the third party/banking server itself. The social component 306 can generate the interface control 508 to add to the measure as feedback thereto such as by incrementing the feedback or attaching a like to the feedback measure. The feedback could be associated or published via a web browser 502 that includes an address bar 504 (e.g., URL bar, location bar, etc.). The web browser 502 can expose a screen 506, which a user can attach to the transaction or communication thread within his or her profile 402 and/or as public feedback such as via the publish component 308, and as a different or same interface control 608 that is illustrated in FIG. 6.

FIG. 6 illustrates another example of a feedback viewing pane, in which the comments can be published and/or different financial measure can be generated from the feedback component, such as a five star system, and/or other like measures for rating the transaction operations 610, and/or the communication thread 612. As stated above, the comments 616 and/or the rating provided could be locally via the interface control 508 and/or or more globally to a network or network portal via the interface control 608. Alternatively, both could be performed by a single interface control (e.g., an interface button, or the like control).

While the methods described within this disclosure are illustrated in and described herein as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the description herein. Further, one or more of the acts depicted herein may be carried out in one or more separate acts and/or phases.

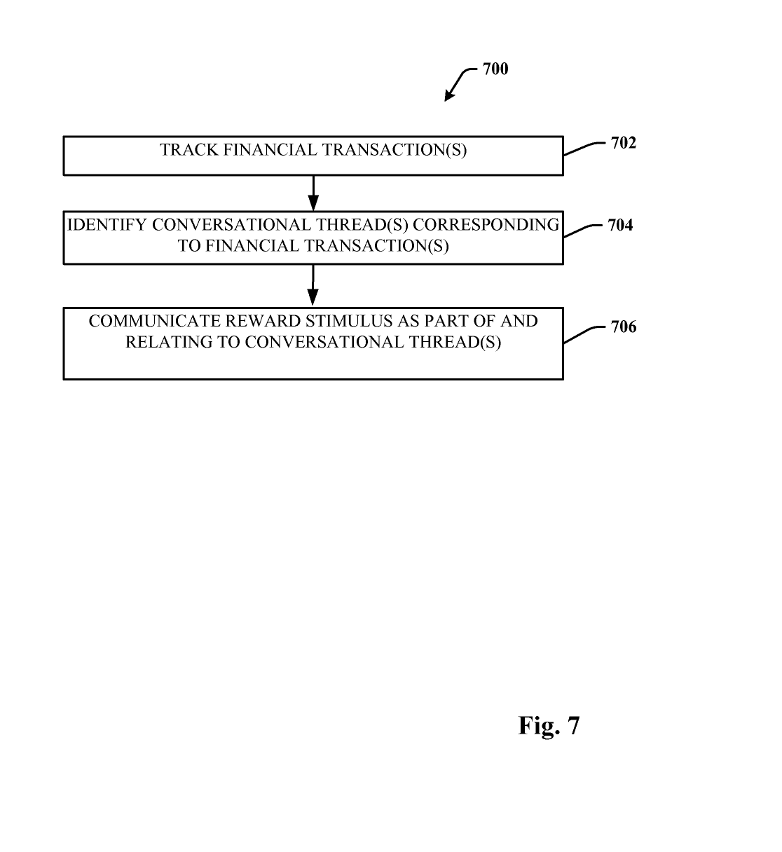

FIG. 7 illustrates a method 700 for generating a reward stimulus such as a loyalty based offer or reward according to various embodiments of this disclosure. At 702, a set (one or more) of financial transactions are tracked by a system comprising at least one processor. The financial transactions can be tracked, for example, via a digital wallet, bank account aggregators, and/or other such information sources of financial data related to a client device.

At 704, one or more conversational threads corresponding to the set of financial transactions is identified. A conversational thread can include any number of communications or correspondence between a client device and a third party vendor or bank server, for example. The communications of the conversational thread, for example, can be part of a purchase or transaction having a receipt, a shipping confirmation, an order, a reservation, and/or any such exchange, which can be digitally generated into one communication thread from different replies/responses from among the client device and/or vendor, and/or a part of the same response and reply communication thread in order to identify or generate a single communication thread.

At 706, a reward stimulus (e.g., a loyalty based offer, promotion, discount, credit, recommendation, referral, and/or the like) can be communicated as part of the conversational thread. In addition, the reward stimulus can be communicated as relating to the subject matter of the conversational thread, either by the product or service as part of the bargained exchange of the transaction, the vendor that was involved in the transactions, and/or both the product, service and/or vendor. For example, a discount on bike accessories could be communicated to the user as part of the same transactional conversational thread involved a purchase for a bike. The user could have purchased the bike online, in which a purchase could have been made electronically, and a corresponding shipping order, confirmation, receipt, etc. was involved. Alternatively or additionally, a bike could have been purchase in a retail store or at a vendor location, in which the receipt, warranty and/or any other like information could be identified/generated into a conversational thread and communicated to the user's client device (e.g., a mobile phone or other device) with the reward stimulus. A user is therefore able to build rapport with vendors, utilize a client device that can search, identify and communicate options related to the context of past transactions, and/or be offered rewards from a banking server for a third party vendor based on one or more transactions logged.

In one embodiment, the method 700 can include identifying or generating a message or a communication having the reward stimulus as part of the communication thread based on a behavioral profile and/or a set of personal data analytics. For example, a client device can store and generate profile of a user/client that identifies personal data such as interest, financial condition, spending habits, important dates, location, and the like to learn about the user and a context that the device finds the user. For example, the client device could identify that the user shops frequently at a particular candy store and has an anniversary or birthday upcoming. A conversational thread from a previous transaction with the candy store vendor can be generated based on this profile of the user and/or the user's context (circumstances or facts that currently surround or are related to the user). The client device, in which the user interacts with, a banking server via the client device, and/or the vendor with access to the profile via the client device can further a communication thread by interacting further with the prior communications within the thread and the reward stimulus to notify the user via the client device of promotions, current discounts, credits, loyalty based programs, recommendations of products or other vendors liked by other users of the user's age, locations, gender, ethnicity, religion, etc., and/or other products/service relate data. Therefore, further conversational exchange, as part of the thread, can be based on a set of predetermined options including at least one of important dates tracked, a device geophysical location, a time of day, a social networking activity, one or more reminders, the behavioral profile, an inquiry detected or feedback received about the set of financial transactions.

In another embodiment, the method can comprise generating an interface control that enables a single input to associate a feedback with a feedback measure to the set of financial transactions. For example, the user can associate feedback to the conversational thread corresponding to one or more transactions. The profile (behavioral profile) can include the feedback, in which one or more reward stimuli can be generated based on the feedback provided in the profile. The feedback can be published to a network or network portal as part of other user feedback to the product, service and/or vendor related to a financial transaction of the conversational thread. The client device can then serve the client based on recommendations, feedback and the like to various vendors, products, services as a parameter to generating the reward stimulus, for example. The feedback can be generated and/or associated via a single interface control, which can be embedded as part of the conversational thread or a separate control that enables associated the conversational thread or the transaction as subject of the thread with the feedback. The feedback can include a like, dislike, a comment, a review and/or operate to rate the transaction with the vendor, either according to the service provided, the vendor quality, as well as rate the product and/or service of the transaction, for example.

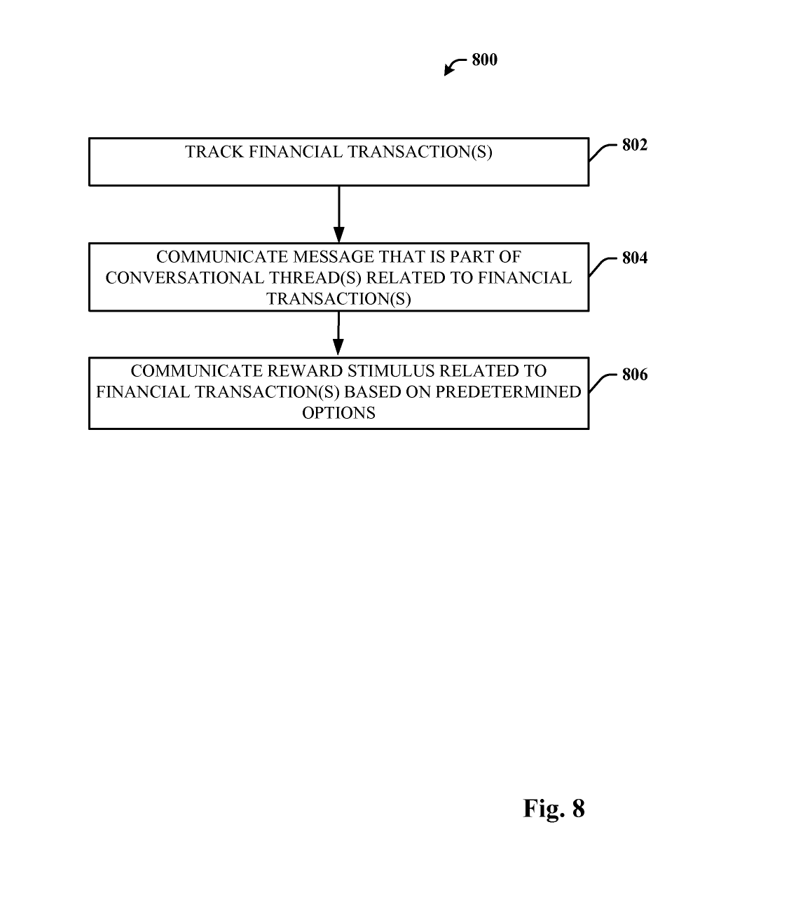

FIG. 8 illustrates an example methodology 800 for generating reward stimulus with one or more transaction logs on a mobile device in accordance with various embodiments described herein. At 802, a set of financial transactions are tracked on a mobile device such as a personal digital assistant, a mobile phone or a similar device. The transactions can include one or more exchanges for products and/or services from a third party vendor and/or a banking server that can be recorded on the personal device as conversational threads via SMS or text message services, multimedia messaging service, electronic mail, and/or other digital form of communication over a network. Alternatively, a transaction having digital communications can be identified or generated into a conversational thread.

At 804, the conversational thread related to the financial transaction is employed to further communicate a message. The message can be integrated with the conversational thread, which builds upon the relationship of the previous transaction history that was logged or stored in the device memory. As such, the message is communicated as part of the conversational thread from prior transactions based on the logged events and/or communications. A third party server or vendor involved in the transaction or not can initiate the message. A banking server involved or not with the transaction can initiate the message. Additionally or alternatively, the client device can initiate the message. Regardless of the initiating entity, the client device is employed to keep a client knowledgeable of ideas, offers, promotions, discounts, credits, loyalty programs and/or other data to goods and services that the client could or likely would appreciate based on a previous context, previous dealings, a profile (behavioral profile), recommendations, other feedback pertaining to the transaction logged or the subject of a thread, and/or the user's feedback, for example.

At 806, for example, the reward stimulus (e.g., the offer, promotions, gift/product/service ideas, discounts, credits, loyalty programs available, etc.) is communicated in relation to the financial transaction based on predetermined options. The predetermine options include, for example, important dates tracked, a device geophysical location, a time of day, a social networking activity, a reminder, a behavioral profile, inquiries detected and/or feedback received about the financial transactions.

In one embodiment, a behavioral profile can be generated that is related to the set of financial transactions. The behavioral profile can include information about a client such as personal data analytics including important dates, networking activity, financial conditions, data about interest (e.g., jewelry, biking, stamps collecting, etc.), spending habits and patterns, feedback provided to vendors/products/services of transactions and/or other behavioral profile information that could be used to continue or facilitate a communication related to logged transactions and a reward stimulus related to the transactions and/or the behavioral profile.

### Exemplary Networked and Distributed Environments

One of ordinary skill in the art can appreciate that the various non-limiting embodiments of the shared systems and methods described herein can be implemented in connection with any computer or other client or server device, which can be deployed as part of a computer network or in a distributed computing environment, and can be connected to any kind of data store. In this regard, the various non-limiting embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the shared shopping mechanisms as described for various non-limiting embodiments of the subject disclosure.

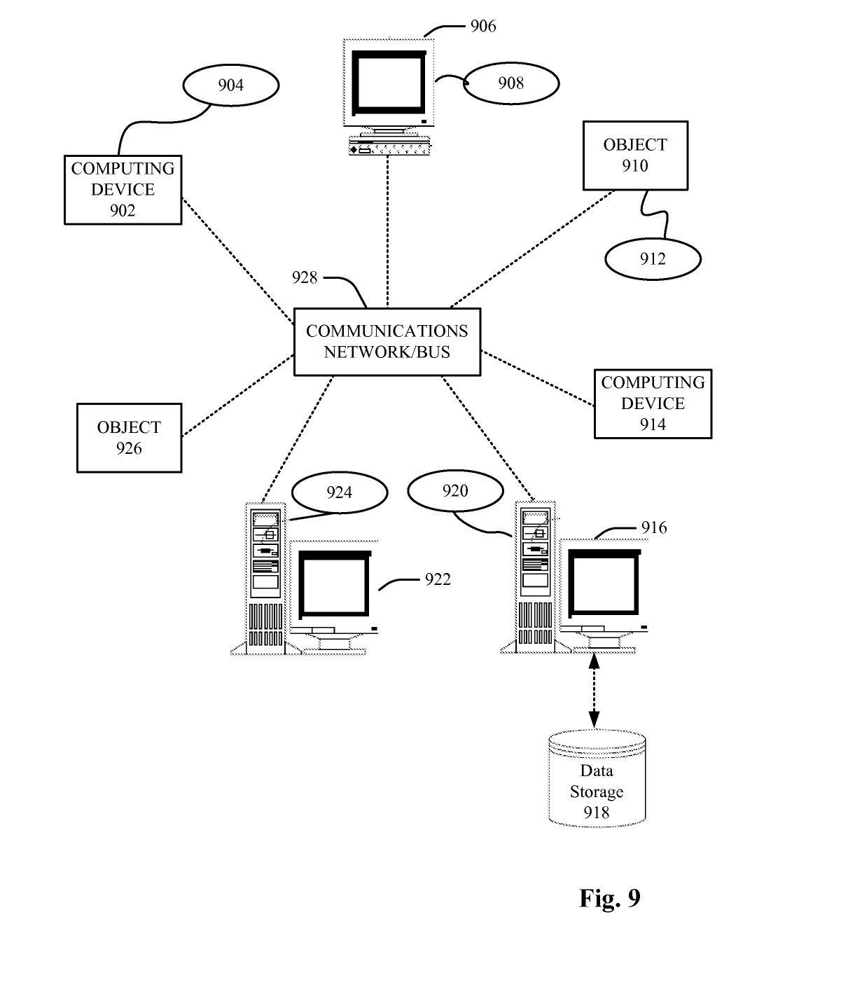

FIG. 9 provides a schematic diagram of an exemplary networked or distributed computing environment. The distributed computing environment comprises computing objects 910, 912, etc. and computing objects or devices 920, 922, 924, 926, 928, etc., which may include programs, methods, data stores, programmable logic, etc., as represented by applications 930, 932, 934, 936, 938. It can be appreciated that computing objects 910, 912, etc. and computing objects or devices 920, 922, 924, 926, 928, etc. may comprise different devices, such as personal digital assistants (PDAs), audio/video devices, mobile phones, MP3 players, personal computers, laptops, etc.

Each computing object 910, 912, etc. and computing objects or devices 920, 922, 924, 926, 928, etc. can communicate with one or more other computing objects 910, 912, etc. and computing objects or devices 920, 922, 924, 926, 928, etc. by way of the communications network 940, either directly or indirectly. Even though illustrated as a single element in FIG. 9, communications network 940 may comprise other computing objects and computing devices that provide services to the system of FIG. 9, and/or may represent multiple interconnected networks, which are not shown. Each computing object 910, 912, etc. or computing object or device 920, 922, 924, 926, 928, etc. can also contain an application, such as applications 930, 932, 934, 936, 938, that might make use of an API, or other object, software, firmware and/or hardware, suitable for communication with or implementation of the shared shopping systems provided in accordance with various non-limiting embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the shared shopping systems as described in various non-limiting embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In client/server architecture, particularly a networked system, a client is usually a computer that accesses shared network resources provided by another computer, e.g., a server. In the illustration of FIG. 9, as a non-limiting example, computing objects or devices 920, 922, 924, 926, 928, etc. can be thought of as clients and computing objects 910, 912, etc. can be thought of as servers where computing objects 910, 912, etc., acting as servers provide data services, such as receiving data from client computing objects or devices 920, 922, 924, 926, 928, etc., storing of data, processing of data, transmitting data to client computing objects or devices 920, 922, 924, 926, 928, etc., although any computer can be considered a client, a server, or both, depending on the circumstances. Any of these computing devices may be processing data, or requesting services or tasks that may implicate the shared shopping techniques as described herein for one or more non-limiting embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 940 or bus is the Internet, for example, the computing objects 910, 912, etc. can be Web servers with which other computing objects or devices 920, 922, 924, 926, 928, etc. communicate via any of a number of known protocols, such as the hypertext transfer protocol (HTTP). Computing objects 910, 912, etc. acting as servers may also serve as clients, e.g., computing objects or devices 920, 922, 924, 926, 928, etc., as may be characteristic of a distributed computing environment.

### Exemplary Computing Device

As mentioned, advantageously, the techniques described herein can be applied to a number of various devices for employing the techniques and methods described herein. It is to be understood, therefore, that handheld, portable and other computing devices and computing objects of all kinds are contemplated for use in connection with the various non-limiting embodiments, i.e., anywhere that a device may wish to engage on behalf of a user or set of users. Accordingly, the below general purpose remote computer described below in FIG. 12 is but one example of a computing device.

Although not required, non-limiting embodiments can partly be implemented via an operating system, for use by a developer of services for a device or object, and/or included within application software that operates to perform one or more functional aspects of the various non-limiting embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is to be considered limiting.

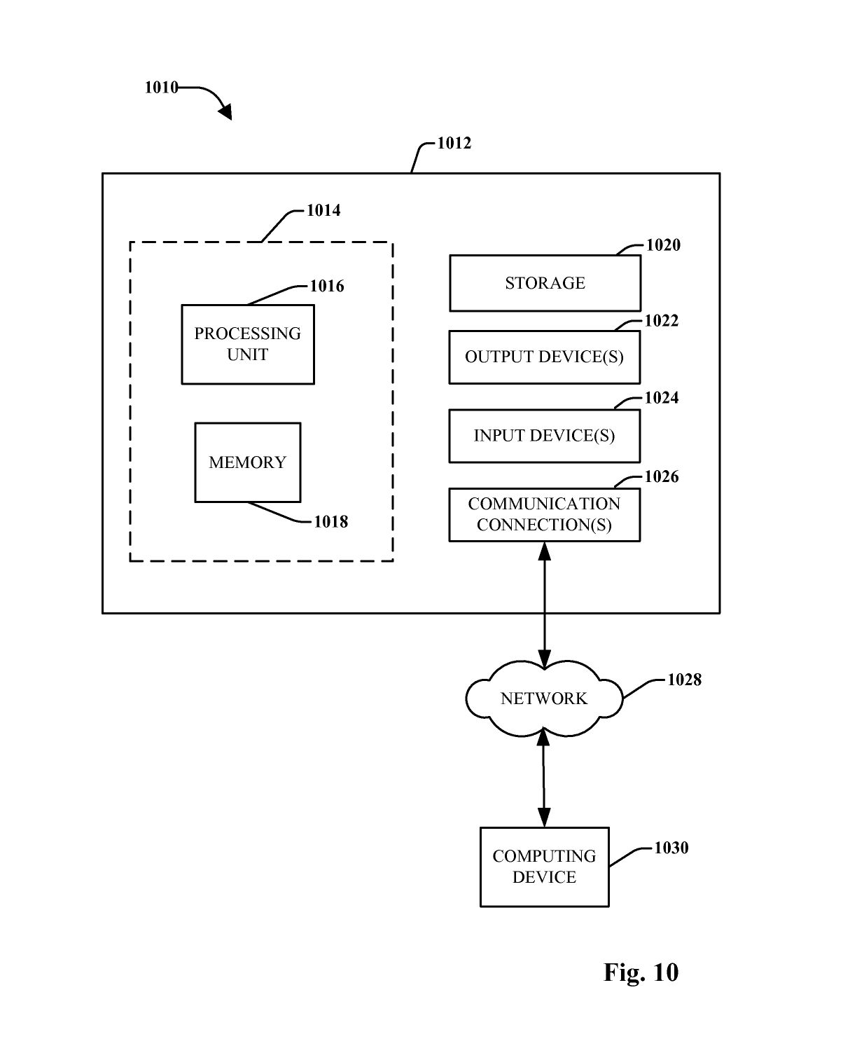

FIG. 10 and the following discussion provide a brief, general description of a suitable computing environment to implement embodiments of one or more of the provisions set forth herein. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 10 illustrates an example of a system 1010 comprising a computing device 1012 configured to implement one or more embodiments provided herein. In one configuration, computing device 1012 includes at least one processing unit 1016 and memory 1018. Depending on the exact configuration and type of computing device, memory 1018 may be volatile (such as RAM, for example), non-volatile (such as ROM, flash memory, etc., for example) or some combination of the two. This configuration is illustrated in FIG. 10 by dashed line 1014.

In other embodiments, device 1012 may include additional features and/or functionality. For example, device 1012 may also include additional storage (e.g., removable and/or non-removable) including, but not limited to, magnetic storage, optical storage, and the like. Such additional storage is illustrated in FIG. 10 by storage 1020. In one embodiment, computer readable instructions to implement one or more embodiments provided herein may be in storage 1020. Storage 1020 may also store other computer readable instructions to implement an operating system, an application program, and the like. Computer readable instructions may be loaded in memory 1018 for execution by processing unit 1016, for example.

The term “computer readable media” as used herein includes computer storage media. Computer storage media includes volatile and nonvolatile, removable and non-removable media implemented in any method or technology for storage of information such as computer readable instructions or other data. Memory 1018 and storage 1020 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1012. Any such computer storage media may be part of device 1010.

Device 1012 may also include communication connection(s) 1026 that allows device 1010 to communicate with other devices. Communication connection(s) 1026 may include, but is not limited to, a modem, a Network Interface Card (NIC), an integrated network interface, a radio frequency transmitter/receiver, an infrared port, a USB connection, or other interfaces for connecting computing device 1012 to other computing devices. Communication connection(s) 1026 may include a wired connection or a wireless connection. Communication connection(s) 1026 may transmit and/or receive communication media.

The term “computer readable media” as used herein includes computer readable storage media and communication media. Computer readable storage media includes volatile and nonvolatile, removable and non-removable media implemented in any method or technology for storage of information such as computer readable instructions or other data. Memory 1018 and storage 1020 are examples of computer readable storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1010. Any such computer readable storage media may be part of device 1012.

Device 1012 may also include communication connection(s) 1026 that allows device 1012 to communicate with other devices. Communication connection(s) 1026 may include, but is not limited to, a modem, a Network Interface Card (NIC), an integrated network interface, a radio frequency transmitter/receiver, an infrared port, a USB connection, or other interfaces for connecting computing device 1012 to other computing devices. Communication connection(s) 1026 may include a wired connection or a wireless connection. Communication connection(s) 1026 may transmit and/or receive communication media.

The term “computer readable media” may also include communication media. Communication media typically embodies computer readable instructions or other data that may be communicated in a “modulated data signal” such as a carrier wave or other transport mechanism and includes any information delivery media. The term “modulated data signal” may include a signal that has one or more of its characteristics set or changed in such a manner as to encode information in the signal.

Device 1012 may include input device(s) 1024 such as keyboard, mouse, pen, voice input device, touch input device, infrared cameras, video input devices, and/or any other input device. Output device(s) 1022 such as one or more displays, speakers, printers, and/or any other output device may also be included in device 1012. Input device(s) 1024 and output device(s) 1022 may be connected to device 1012 via a wired connection, wireless connection, or any combination thereof. In one embodiment, an input device or an output device from another computing device may be used as input device(s) 1024 or output device(s) 1022 for computing device 1012.

Components of computing device 1012 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 1012 may be interconnected by a network. For example, memory 1018 may be comprised of multiple physical memory units located in different physical locations interconnected by a network.

Those skilled in the art will realize that storage devices utilized to store computer readable instructions may be distributed across a network. For example, a computing device 1030 accessible via network 1028 may store computer readable instructions to implement one or more embodiments provided herein. Computing device 1012 may access computing device 1030 and download a part or all of the computer readable instructions for execution. Alternatively, computing device 1012 may download pieces of the computer readable instructions, as needed, or some instructions may be executed at computing device 1012 and some at computing device 1030.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. An apparatus, comprising:
a memory to store computer-executable instructions; and
a processor, communicatively coupled to the memory, that facilitates execution of the computer-executable instructions to at least:
identify a set of communications related to a financial transaction stored in the memory;
generate a communication message related to the financial transaction and as part of the set of communications; and
offer an award as part of and related to the set of communications.

2. The apparatus of claim 1, wherein the processor further facilitates execution of the computer-executable instructions to:
generate a behavioral profile based on the financial transaction recorded on the memory, wherein the communication message is based on the behavioral profile.

3. The apparatus of claim 2, wherein the processor further facilitates execution of the computer-executable instructions to:
analyze spending habits to generate the behavioral profile.

4. The apparatus of claim 3, wherein the spending habits comprise at least one of payment patterns, debt accumulation data, expense data, income data, or interest rate data.

5. The apparatus of claim 1, wherein the processor further facilitates execution of the computer-executable instructions to:
generate a reward option for selection as the award based on the behavioral profile.

6. The apparatus of claim 5, wherein the award is communicated from a third party vendor device that is communicatively coupled to the memory.

7. The apparatus of claim 2, wherein the processor further facilitates execution of the computer-executable instructions to:
initiate the communication message based on a set of predetermined options based on at least one of a date, a geophysical location, a time of day, a social networking activity, a reminder, the behavioral profile, an inquiry detected or feedback received about the financial transaction.

8. The apparatus of claim 2, wherein the processor further facilitates execution of the computer-executable instructions to:
determine a set of user preferences based on the behavioral profile and communicate the communication message based on the set of user preferences, wherein the set of user preferences include at least one of a tone, a gender, a dialect, a language, or a grammar construction.

9. The apparatus of claim 1, wherein the processor further facilitates execution of the computer-executable instructions to:
generate an interface control that enables a single input to associate feedback for a feedback measure associated with the financial transaction; and
publish the feedback to one or more network devices for sharing the feedback.

10. The apparatus of claim 1, wherein the processor further facilitates execution of the computer-executable instructions to:
communicate with a banking server regarding the financial transaction to prompt initiation of the communication message.

11. A system, comprising:
a memory that stores computer-executable components; and
a processor, communicatively coupled to the memory, that facilitates execution of the computer-executable components, the computer-executable components comprising:
a profile component configured to generate a profile based on a set of financial transactions;
an interaction component configured to facilitate a communication thread including a plurality of communications with a client device with a communication based on the profile; and
a reward component configured to generate an offer with a reward stimulus as a part of and related to the communication thread.

12. The system of claim 11, wherein the interaction component is further configured to receive a response based on the communication thread and continue the communication thread based on the response.

13. The system of claim 11, wherein the computer-executable components further comprise:
a transaction component configured to generate a transaction record of the set of financial transactions that comprises the communication thread; and
a personal data component configured to determine a set of personal data analytics based on a set of inputs that relate to financial data identified from the transaction record.

14. The system of claim 13, wherein the profile component is further configured to generate the profile based on the set of personal data analytics and to determine items of potential interest from the set of personal data analytics, and wherein the interaction component is further configured to facilitate the communication thread based on the set of personal data analytics or the items of potential interest.

15. The system of claim 11, wherein the computer-executable components further comprise:
a banking server component configured to communicate at least one transaction to the profile component and prompt the interaction component to initiate the communication thread.

16. The system of claim 15, wherein the reward component is further configured to generate the offer including the reward stimulus as corresponding to a third party product or service.

17. The system of claim 11, wherein the computer-executable components further comprise:
a feedback component configured to enable a feedback measure that is related to the communication thread.

18. The system of claim 17, wherein the feedback measure is configured to rate a financial transaction of the set of financial transactions that the communication thread is associated with and provide a rating associated with a third party vendor associated with the financial transaction.

19. The system of claim 11, wherein the reward stimulus comprises a discount, credit, recommendation or promotion to purchase at a third party vendor from a separate banking server.

20. The system of claim 11, wherein the computer-executable components further comprise:
a social component configured to generate an interface control that enables a single input to associate feedback to a feedback measure for a financial transaction stored in a transaction record or the profile.

21. The system of claim 20, wherein the computer-executable components further comprise:
a publish component configured to publish the feedback with one or more networks or network portals.

22. The system of claim 11, wherein the computer-executable components further comprise:
a personality analysis component configured to determine a set of user preferences based on the profile.

23. The system of claim 22, wherein the interaction component is further configured to facilitate the communication based on the set of user preferences that comprise at least one of a tone, a gender, a dialect, a language, or a grammar construction.

24. The system of claim 11, wherein the interaction component is further configured to initiate the communication based on a set of predetermined options including based on at least one of a date tracked, a device geophysical location, a time of day, a social networking activity, a reminder, the profile, an inquiry detected or feedback received about the set of financial transactions.

25. The system of claim 11, wherein the profile component is further configured to track purchases and analyze spending habits determined from the purchases to generate the profile.

26. The system of claim 25, wherein the spending habits comprise at least one of payment patterns, debt accumulation data, expense data, income data, or interest rate data from the set of financial transactions.

27. The system of claim 26, wherein the reward component is further configured to generate options for selection as the reward stimulus based on the profile.

28. The system of claim 27, wherein the computer-executable components further comprise:
a transaction component configured to generate a transaction record of the set of financial transactions via the client device,
wherein the reward stimulus is communicated from a third party vendor device that is communicatively coupled to the transaction component and has access to the transaction record.

29. A method comprising:
tracking, by a system comprising at least one processor, a set of financial transactions;
identifying a conversational thread corresponding to the set of financial transactions; and
communicating, via a mobile device, a reward stimulus as a part of and relating to the conversational thread.

30. The method of claim 29, wherein the conversational thread is identified on the mobile device by a banking server and the reward stimulus corresponds to a third party vendor associated with the conversational thread.

31. The method of claim 29, further comprising:
generating a behavioral profile based on the set of financial transactions and a set of personal data analytics; and
facilitating a conversational exchange based in part on the behavioral profile and as part of the conversational thread and the reward stimulus.

32. The method of claim 31, further comprising:
generating an interface control that enables a single input to associate a feedback with a feedback measure to the set of financial transactions.

33. The method of claim 31, further comprising:
publishing a feedback associated with the set of financial transactions to one or more networks or network portals with a single interface control embedded within the conversational thread.

34. The method of claim 31, further comprising:
receiving a communication to facilitate the conversational exchange from a third party vendor having access to the behavioral profile.

35. The method of claim 29, further comprising:
presenting the conversational thread in a message with the reward stimulus, wherein the reward stimulus comprises at least one of a discount, a credit, a recommendation, a referral, a promotion, a product, a service or additional information associated with the set of financial transactions.

36. The method of claim 31, further comprising:
facilitating the conversational exchange based on a set of predetermined options including at least one of dates tracked, a device geophysical location, a time of day, a social networking activity, one or more reminders, the behavioral profile, an inquiry detected or feedback received about the set of financial transactions.

37. A tangible computer readable storage medium comprising computer executable instructions that, in response to execution, cause a computing system comprising a processor to perform operations, comprising:
tracking a set of financial transactions;
communicating a message as part of a conversational thread related to the set of financial transactions; and
communicating a reward stimulus in the message that is related to the set of financial transactions and based on a set of predetermined options.

38. The tangible computer readable storage medium of claim 37, wherein the set of predetermined options comprise parameters comprising at least one of a date tracked, a device geophysical location, a time of day, social networking activities, one or more reminders, a behavioral profile, an inquiry detected or feedback received about the set of financial transactions.

39. The tangible computer readable storage medium of claim 37, the operations further comprising:
generating a behavioral profile related to the set of financial transactions and including feedback associated with the set of financial transactions.

40. The tangible computer readable storage medium of claim 39, the operations further comprising:
generating the reward stimulus based on the feedback and the set of financial transactions that correspond to the feedback.

41. The tangible computer readable storage medium of claim 40, the operations further comprising:
generating an interface control as part of the conversational thread that enables the feedback to be associated with the set of financial transactions.

42. The tangible computer readable storage medium of claim 41, the operations further comprising:
sharing the feedback with one or more networks or network portals.
